(19) United States
(12) Patent Application Publication
(10) Pub. No.: US 2018/0020634 A1
(43) Pub. Date: Jan. 25, 2018

(54) Horse trailer corral

(71) Applicant: Matthew Mazzilli, Okeechobee, FL (US)

(72) Inventor: Matthew Mazzilli, Okeechobee, FL (US)

(21) Appl. No.: 15/656,719

(22) Filed: Jul. 21, 2017

Related U.S. Application Data
(60) Provisional application No. 62/365,116, filed on Jul. 21, 2016.

(51) Int. Cl. A01K 1/00; A01K 1/10; A01K 7/00

(52) U.S. Cl. CPC A01K 1/0035; A01K 7/00; A01K 1/10; A01K 1/0094

(57) ABSTRACT

A portable corral that is hinged to the side of a horse trailer. The horse corral consists of fence panel sections that are stored flush against the side of a horse trailer and, by use of a hinge system, fold outwardly to form a corral. Two fence sections are hingedly coupled to a trailer side. An additional fence section, hingedly coupled to one of the trailer mounted fence sections, form a square or rectangular corral. One of the fence sections may include a gate for ease of entry and exit to the corral. When the corral is not in use, the fence sections are rotated back against the side wall of the trailer for storage. Adjustable feet are used for leveling of the fence sections and are retractable for storage.

### PRIORITY CLAIM

In accordance with 37 C.F.R. §1.76, a claim of priority is included in an Application Data Sheet filed concurrently herewith. Accordingly, the present invention claims priority to U.S. Provisional Patent Application No. 62/365,116, entitled “HORSE TRAILER CORRAL”, filed Jul. 21, 2016. The contents of which the above referenced application is incorporated herein by reference.

### FIELD OF THE INVENTION

This invention is related to the field of horse trailers and, in particular, to the incorporation of a horse corral with a horse trailer.

### BACKGROUND OF THE INVENTION

Trailers are the preferred mode of transporting horses from one location to another. Horse trailers are designed for the comfort of the horse with ease of entry ramps, alignment stalls, and windows for ventilation. However, even if the trailer is used to transport the horse a short distance, the trailer subjects the horse to stress. A trailer is not natural to a horse, and it is not possible to suppress a horse's basic inclination for freedom.

It has been reported that a horse being transported in a trailer uses as much energy as when the horse is walking because of the energy used to maintain its balance in a moving vehicle. Stationary for hours on end, the natural tendency of the horse is to find the best balance position which requires constant movement as the trailer is moved. Further, horses can become dehydrated due to water loss as a result of increased respiration issues that occur when a horse is in a trailer, as well as the reduced water consumption likely during transport. Dehydration can lead to reduced gut motility, which, coupled with restricted activity imposed by hauling and reduced food intake, can result in colic. Inadequate hydration contributes to heat exhaustion and possible heat stroke.

Proper trailering of a horse is best obtained by managing known complications and returning the horse to an open space as quickly as possible. Various trailering tactics include: transporting the horse at night or at least during the cooler parts of the day; proper hydrating of the horse prior to the start of the trip; and providing breaks in the travel to allow the horse to step outside the trailer confines. Exiting the trailer during a trip can be very important, especially when hot, humid weather can create a condition inside the trailer that is hotter and more humid than conditions outside the trailer. Adequate trailer ventilation is crucial, especially when the trailer is not in motion.

It is a general rule that the trailer should be stopped every four to six hours to allow the horse a rest and watering break. Ideally, the horse is removed from the trailer, however, keeping a bit or bridle on the horse can cause problems when a horse tries to eat or drink water. Leaving a horse loose is not recommended immediately after trailering. Even if the horse is familiar with trailering, any adverse experience to the trailering experience can “spook” the horse.

A stop, at least 20 minutes long, should be made every couple of hours to allow the horse to relax. In such a situation, the handler may walk the horse and look for a closed area, such as a pen, so the horse can relax without being held. It is recommended that, for trips lasting longer than 12 hours, horses should be given an 8-hour rest from trailering. There are many stables, fairgrounds, and rodeo arenas which provide overnight accommodations for horses. However, there are times when the facilities are full or otherwise unacceptable.

U.S. Pat. No. 6,477,985 discloses an apparatus and method for converting a stock trailer into a horse trailer. Dividers are mounted on the inside of a stock trailer to create separate compartments for a number of horses. When the trailer reaches its destination, the dividers can be removed and used in combination with the stock trailer to create a corral for the horses. However, this uses valuable space within the trailer and requires an individual to physically lift fence sections for installation.

What is lacking in the art is a horse trailer having hinged and easy to maneuver fence panel sections that form a temporary horse corral.

### SUMMARY OF THE INVENTION

Disclosed is an apparatus that is hinged to the side of a horse trailer for storage and shipping, and folds out to form a horse corral. In the preferred embodiment, the horse corral consists of three fence panel sections that are stored flush against the side of a horse trailer. A first fence section has an inner end and an outer end; the inner end is hingedly coupled to a trailer side and the outer end is movable from a storage position next to said trailer side to a deployed position perpendicular to the trailer side. A second fence section has a substantially rectangular shape with a first end hingedly coupled to the outer end of the first panel and a second end movable from a stored position next to the first section inner end to a deployed position spaced apart from the trailer side. A third fence section has a proximal end and a distal end; the proximal end is hingedly coupled to the trailer side and the distal end movable from a stored position next to said inner end of the first fence section to a deployed position adjacent to the second end of the second fence section, wherein a side of the trailer and the three fence sections form a corral.

The use of hinged fence panel sections permits the storage of all three fence panel sections without lifting. Upon deployment, adjustable feet provided on each panel section are lowered to support the weight of the fences panel sections and provide a level stance for each fence panel.

It is an objective of the invention to provide a horse corral that is stored along the side of a horse trailer and, upon deployment, forms a corral using the horse trailer as one side of the corral.

Still another objective of the invention is to disclose a horse corral that can be deployed by rotating fence panels into position, with each fence panel hingedly coupled to an adjacent fence panel.

Yet still another objective of the invention is to disclose a horse corral made of lightweight aluminum rails, allowing individual fence panels to be easily moved from a storage position adjacent one side of a horse trailer to a deployed position with each fence section placed perpendicular to the adjacent fence panel.

Another objective of the invention is to provide a gate within one of the fence panel sections to allow ease of access to the corral area.

Still another objective of the invention is to combine aluminum rails with rigid plastic rails to reduce fence panel weights.

Yet still another objective of the invention is to combine or replace aluminum rails with a flexible plastic strip that is retractable into spring loaded holders.

An advantage of the invention is to utilize equal sized fence sections allowing for 8×8, 10×10 or 12×12 corral sizes.

Still another advantage of the invention is to provide customized sized corrals such as 10×8, 12×8, 10×12 or the like.

Yet another advantage of the invention is the employment of a trailer side which may include a retractable awning to provide a temporary rain and sun shelter over part of the corral.

Other objectives and further advantages and benefits associated with this invention will be apparent to those skilled in the art from the description, examples and claims which follow.

### BRIEF DESCRIPTION OF THE DRAWINGS

FIG. 1 is a pictorial view of the horse trailer corral;

FIG. 2 is a pictorial view of the horse trailer corral in a semi-open position.

FIG. 3 is a plane view of the second fence panel section and gate;

FIG. 4 is a front view of a fence panel section using straps;

FIG. 5 is a perspective view of a fence holder retaining clip;

FIG. 6 is a perspective of an alternative embodiment having a fence frame positionable over a wheel fender housing;

FIG. 7 is a front view of FIG. 6;

FIG. 8 is a front view of a right panel in a raised and stored position;

FIG. 9 is a front view of a left and center panel in a raised and stored position;

FIG. 10 is a side view of the fence frame of FIG. 6 in a stored position;

FIG. 11 is a perspective of the fence frame of FIG. 6 is a stored position;

FIG. 12 is a perspective view of the hinge mechanism for the fence frames;

FIG. 13 is an enlarged view of the vertical slide;

FIG. 14 is a perspective view of another embodiment employing webbing in a deployed position;

FIG. 15 is a perspective view of the webbing embodiment in a storage position;

FIG. 16 is a perspective view of the winding mechanism;

FIG. 17 is an enlarged exploded view of a locking handle for the winding mechanism;

FIG. 18 is a perspective view of alternative support bases; and

FIG. 19 is a perspective view of support bases on a corral.

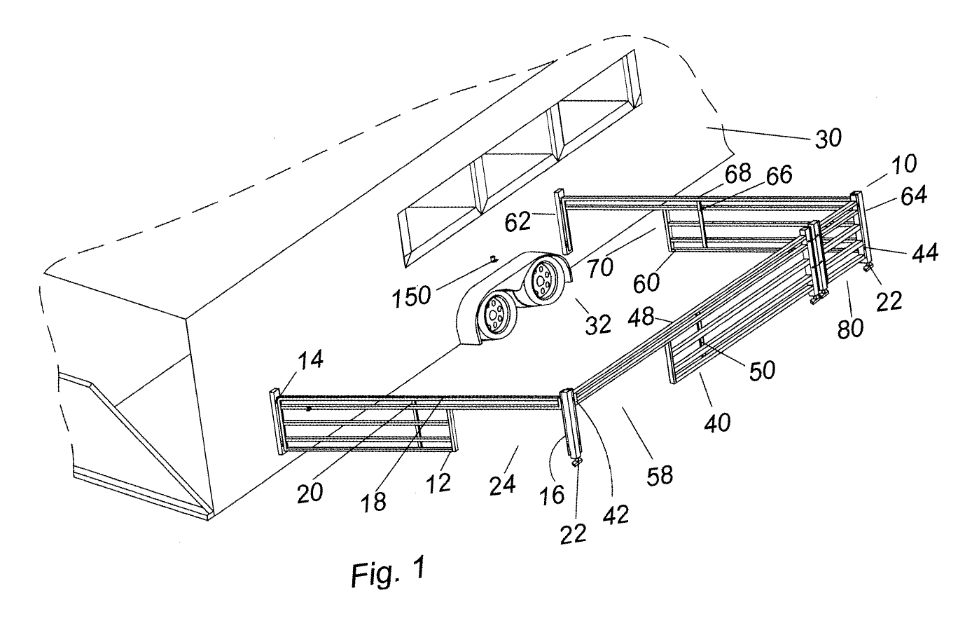

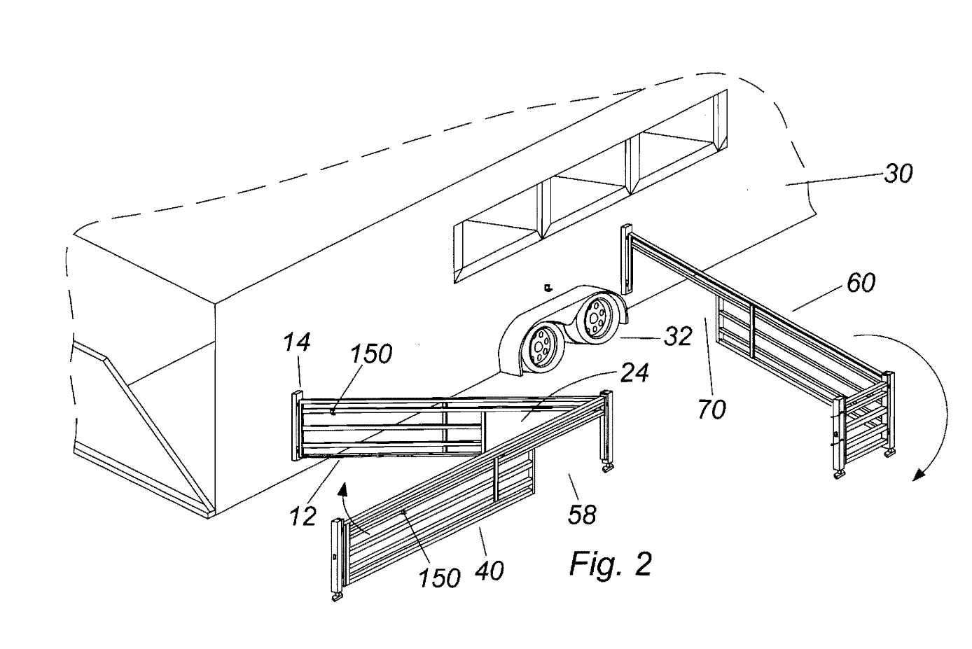

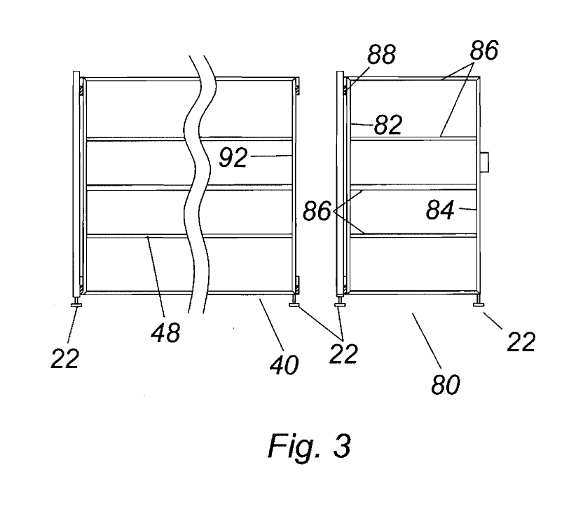

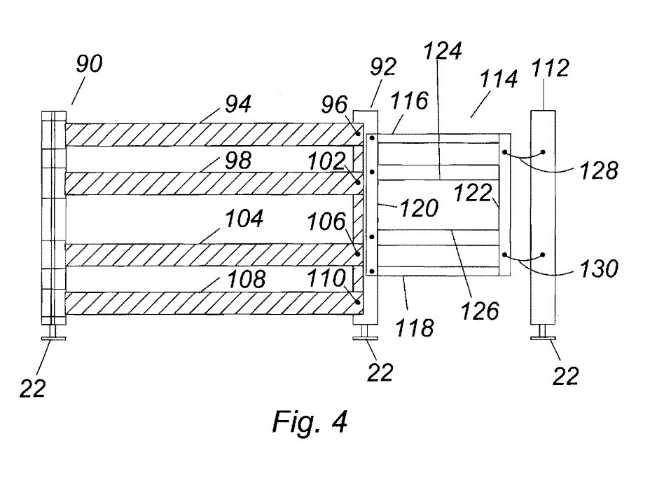

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Referring now to the Figures, the horse trailer corral is formed from a first fence section 12 having a substantially rectangular shape with an inner end 14 and an outer end 16. The inner end 14 is hingedly coupled to a trailer side 30, and the outer end 16 is movable from a storage position next to the trailer side 30 to a deployed position perpendicular to the trailer side 30. The fence sections include a plurality of horizontal rails 18 placed between the inner end 14 and the outer end 16. For stability, uprights 20 provide rigidity for the horizontal rails 18. In the preferred embodiment, at least one adjustable foot 22 is secured to the base of the outer end 16. The foot 22 can be threaded to the outer end 16 to enable leveling of the fence panel section. A section 24 of the horizontal rails can be removed to allow for placement of the fence section over the wheel housing 32 when the fence section is placed against the trailer side 30 for storage.

A second fence section 40 has a first end 42 and a second end 44. The first end 42 is hingedly coupled to the outer end 16 of the first panel 12. The second end 44 is movable from a stored position next to the first section inner end 14 to a deployed position spaced apart from the trailer side 30. At least one adjustable foot 22 is secured to the base of the second end 44. The foot 22 can be threaded to the second end 44 to enable leveling of the fence panel section. The second fence section 40 includes a plurality of horizontal rails 48 placed between the first end 42 and the second end 44. For stability, uprights 50 provide rigidity for the horizontal rails 48. A section 58 of the horizontal rails can be removed to allow for placement of the fence section over the wheel housing 32 when the fence section is placed against the trailer side 30 for storage.

A third fence section 60 has a substantially rectangular shape with a proximal end 62 and a distal end 64. The proximal end 62 is hingedly coupled to the trailer side 30 with the distal end 64 movable from a stored position next to the inner end 14 of the first fence section 12 to a deployed position adjacent the second end 44 of the second fence section 40. The third fence section 60 includes a plurality of horizontal rails 68 placed between the proximal end 62 and the distal end 64. For stability, uprights 66 provide rigidity for the horizontal rails 68. A section 70 of the horizontal rails can be removed to allow for placement of the fence section over the wheel housing 32 when the fence section is placed against the trailer side 30 for storage.

In the preferred embodiment, the height of the fence panel sections is about 54 inches, with the individual panel sections about 48 inches in height. The corral can be made of equal sized fence sections, allowing for 8×8, 10×10 or 12×12 corral size. Alternatively, the fence panel sections can be of a customized size, wherein corrals may be formed of sizes such as 10×8, 12×8, 10×12 or the like.

The fence sections are preferably made of lightweight tubular aluminum using ¾ inch or 1 inch rails and uprights. In another embodiment, the rails can be made telescoping, wherein a rail can slide within another rail so as to reduce the length of the fence panels for shipping. For instance, a first fence section can be reduced from 8 foot in length to less than 3 feet if a telescoping rail is employed. A telescoping rail can be constructed in a manner similar to a telescoping pole commonly found. Alternatively, at least one rail can be constructed of plastic or webbing to further reduce the weight of the fence sections.

In yet another embodiment, one or more rails can be made of a retractable textile strip that can be rolled into a casing for storage. In particular, the textile strip would be 5% inch nylon webbing. In this embodiment, a 6×6 aluminum housing is mounted to the trailer which encases 6-inch spring loaded reels with a locking mechanism to maintain the webbing at a fixed distance. The webbing allows for the replacement of one or two horizontal rails when an upper and lower aluminum rail is maintained for spacing. Alternatively, all rigid rails can be replaced with webbing, wherein the end uprights for an adjacent fence panel section are employed as the receptacle to hold the end of the webbing.

The adjustable feet 22 are formed from a base platform having a threaded rod rotatably secured to a reciprocal threaded receiver positioned on the bottom edge of the fence panel section. Rotation of the threaded rod is used to position the base on the ground to support each fence section.

To allow for ease of entry and exit, one of the fence panel sections may include a gate. Depicted is the second fence panel section 40 which can include a 30-inch gate having uprights 82 and 84 and horizontal rails 86. The upright 82 includes hinges 88 and 90 for pivoting about the second end 92 with a latching mechanism for securement to the distal end 64 of the third fence panel 60.

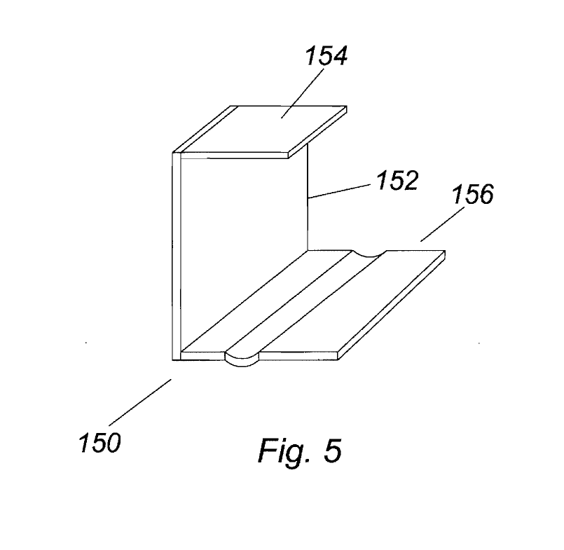

FIG. 5 depicts a lightweight fence section having a first rigid end post 90 spaced apart from a second end post 92. The first end post 90 having a spring loaded retractable pulley housing a first flexible strap 94 having a distal end 96 for coupling to the second end post 92; a second flexible strap 98 having a distal end 102 for coupling to the second end post 92; a third flexible strap 104 having a distal end 106 for coupling to the second end post 92; and a forth flexible strap 108 having a distal end 110 for coupling to the second end post 92. The lightweight fence sections can replace one or more of the above mentioned rigid fence sections.

A gate 114 may also be formed from straps further depicted in FIG. 5. In this embodiment a rigid post 112 maybe used to engage gate 114 having a rigid frame depicted by upper cross bar 116, lower cross bar 118 and opposing ends 120 and 122. Flexible straps 124 and 126 provide a lightweight fence guard between the opposing ends 120 and 122. The gate 114 can be attached to the rigid post 112 by flexible hinges 128 and 130, constructed from line or strap.

The fence sections can be attached to the trailer by the use of holding brackets 150. The holding brackets 150 having a back wall 152, and upper wall 154 and a lower wall 156. The holding brackets can be attached to the side of the trailer and to the outer edge of the fence sections for holding individual sections in place.

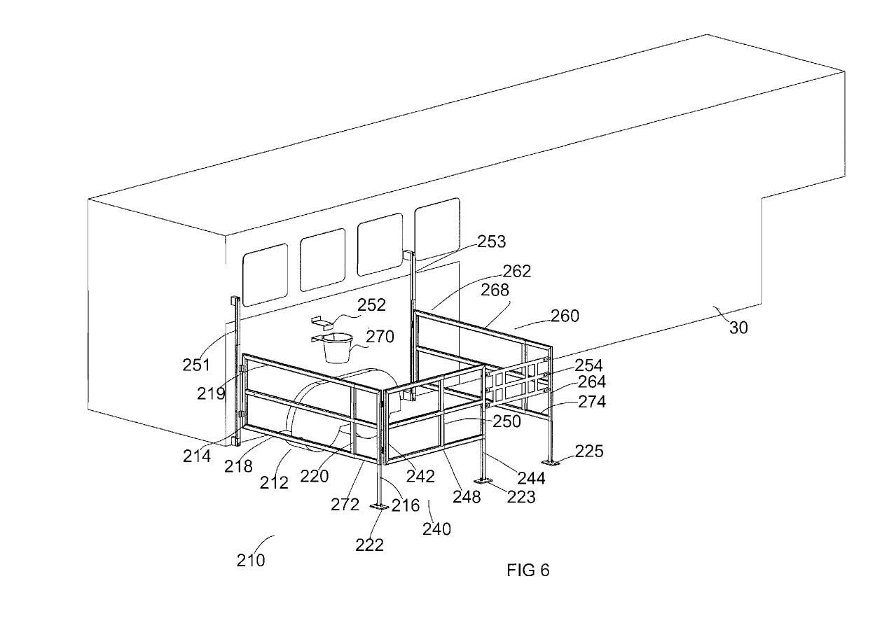

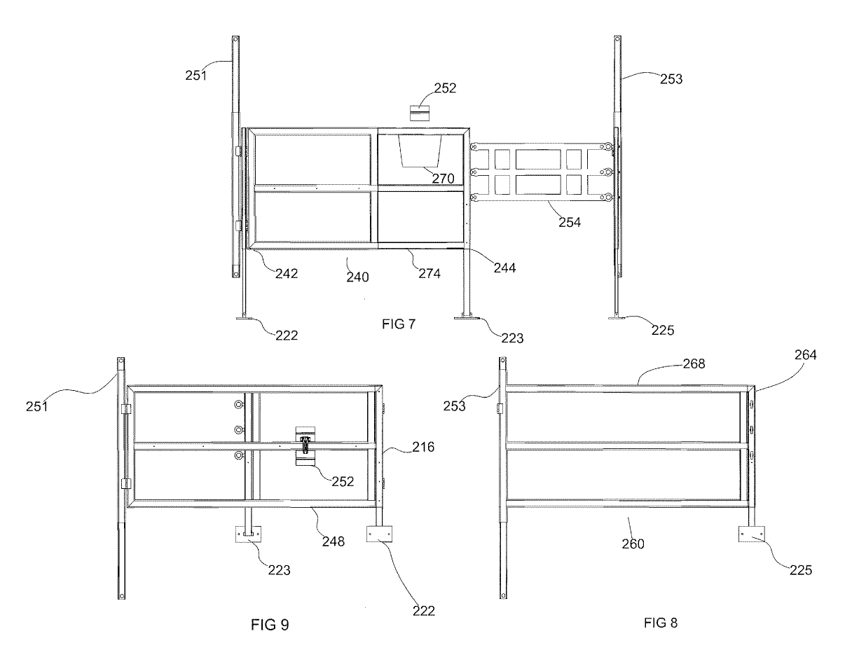

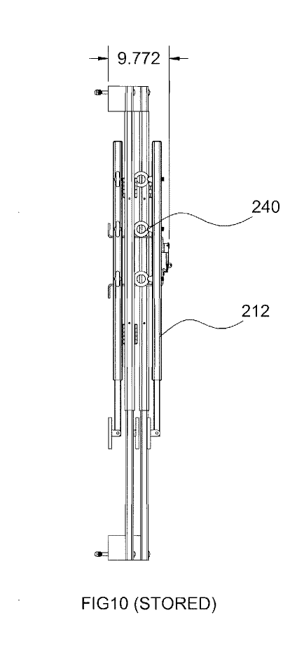

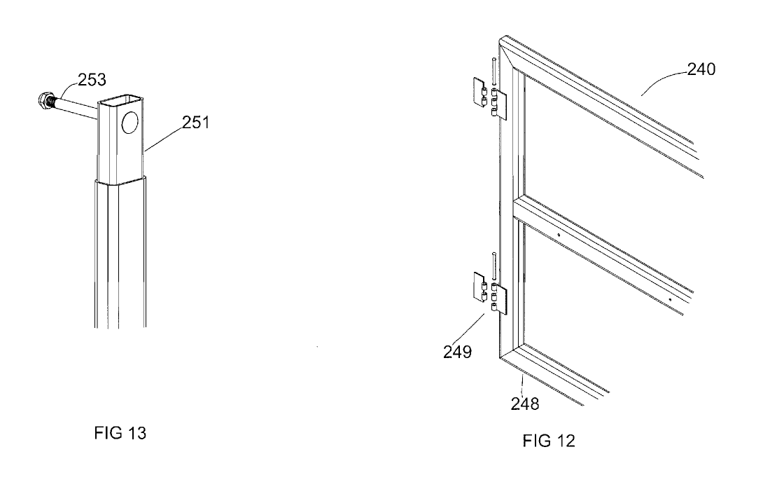

Referring now to FIGS. 6-13, set forth is another embodiment wherein the fence frame is stored in a raised position. In this embodiment, the horse trailer corral 210 is formed from a first fence section 212 having a substantially rectangular shape with an inner end 214 and an outer end 216. The inner end 214 is hingedly coupled to a trailer side 30, and the outer end 216 is movable from a storage position next to the trailer side 30 to a deployed position perpendicular to the trailer side 30. The fence sections include a plurality of horizontal rails 218 placed between the inner end 214 and the outer end 216. For stability, uprights 220 provide rigidity for the horizontal rails 218. In the preferred embodiment, at least one adjustable foot 222 is secured to the base of the outer end 216. The foot 222 can be threaded to the outer end 216 to enable leveling of the fence panel section. The inner end 214 is slidably secured to a vertical slide rail 219 allowing the fence to be raised to a position that allows for placement over the wheel housing 32 when the fence section is placed against the trailer side 30 for storage.

A second fence section 240 has a first end 242 and a second end 244. The first end 242 is hingedly coupled to the outer end 216 of the first panel 212. The second end 244 is movable from a stored position next to the first section inner end 214 to a deployed position spaced apart from the trailer side 230. At least one adjustable foot 223 is secured to the base of the second end 244. The foot 223 can be threaded to the second end 244 to enable leveling of the fence panel section. The second fence section 240 includes a plurality of horizontal rails 248 placed between the first end 242 and the second end 244. For stability, uprights 250 provide rigidity for the horizontal rails 248. A flexible strap gate 254 is releasably attached to the second end to allow ease of ingress for the horses placed in the corral. When the strap gate 254 is removed, the second fence section 240 is folded adjacent the first fence section 212 wherein the frames can lay flush against the trailer. In the preferred embodiment, the first fence section 212 is secured to vertical slide rail 251. The slide rail is fastened to the trailer 30 by a bolt 253 or the like. The vertical slide rail 251 operates as base and the first end 214 of the first fence section 212 operates as a sleeve allowing the first fence section 212 to be raised to a position wherein the lower horizontal rail 218 is placed over the wheel housing 32. The upper horizontal rail 219 fits within, and is held in position by the storage bracket 252. The storage bracket 252 is constructed and arranged to hold the fence sections in a fixed position against the side 32 of the trailer 30 and allow quick release when desired.

A third fence section 260 has a substantially rectangular shape with a proximal end 262 and a distal end 264. The proximal end 262 is hingedly coupled to the trailer side 30 with the distal end 264 movable from a stored position toward the inner end 214 of the first fence section 212 to a deployed position adjacent the second end 244 of the second fence section 240. The third fence section 260 includes a plurality of horizontal rails 268 placed between the proximal end 262 and the distal end 264, and adjustable foot 225. The adjustable feet 222, 223 and 225 are preferable on a hinge allowing compact storage when placed against the trailer. The hinged foot also eliminates a protruding edge of the feet from extending outward while in a storage position. The feet are rotatable from a vertical position while in storage, to a horizontal position for weight distribution on the ground. The inner end 262 is slidably secured to a vertical slide rail 253 allowing the fence section to be raised to a position that allows for placement over the wheel housing 32 when the fence section is placed against the trailer side 30 for storage.

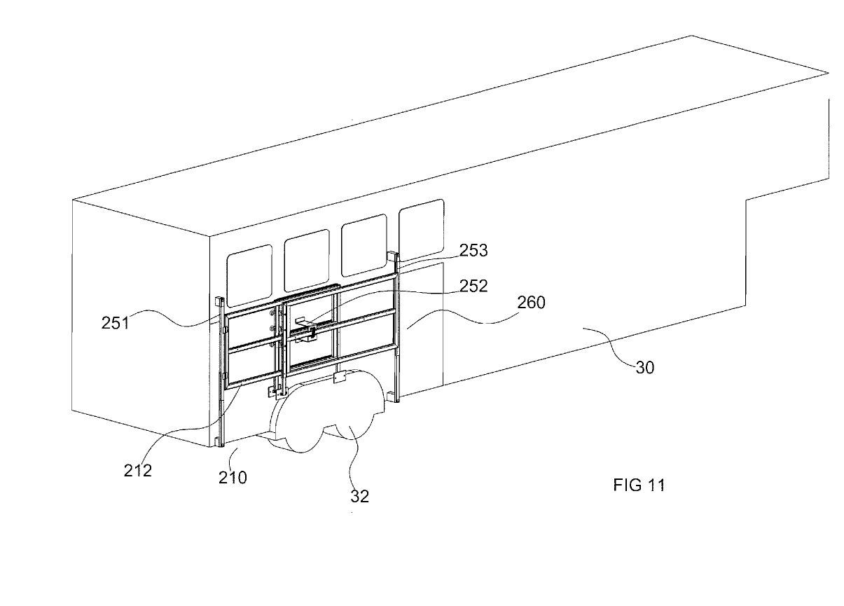

Each of the fence section 212, 240 and 260 have one end that is hinged 249 allowing the fence sections to be placed into perpendicular positions to form the corral as depicted in FIG. 6, or folded into a storage position as depicted in FIG. 11. In the exemplary embodiment, when in a storage position the width of the fence sections is about 9.772 inches wide and the length is about 122 inches. In another embodiment, the fence frame sections 212 and 260 can be made to telescope. Fence frame section 212 includes expansion section 272 having horizontal rails that are slidable insertable of adjoining rails. Similarly, fence frame section 260 is slidable insertable into the adjoining rails. The second fence frame section 240 can further include an adjustable frame section 274 which allows the center frame to be moved to assure proper gate 254 opening or to assure the feet are placed in the most suitable ground conditions. When the fence sections are in a deployed position, a water or feed bucket 270 can be secured to the storage bracket 252.

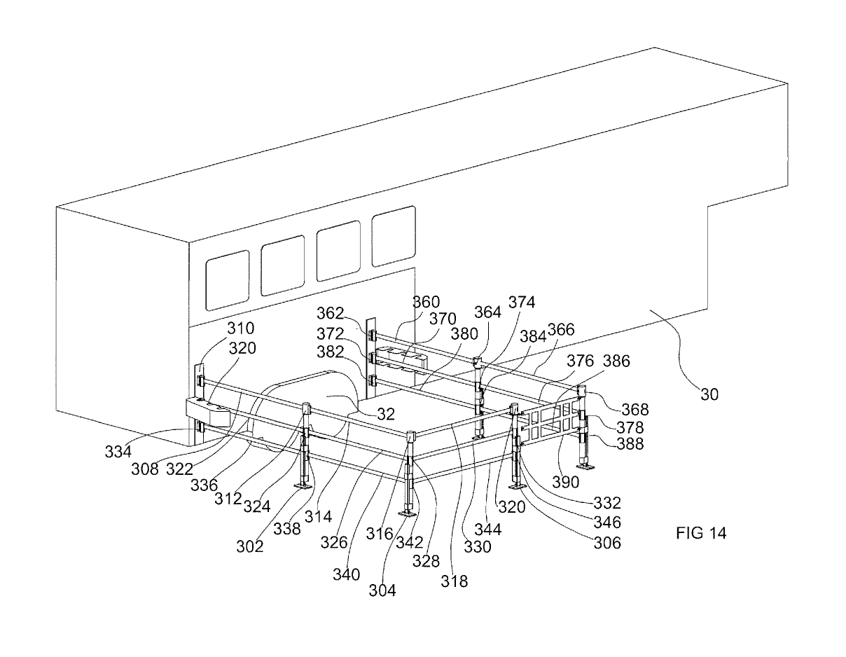

Referring now to FIGS. 14-19, set forth is an alternative embodiment having a trailer 30 with a corral having three stanchions forming an L-shape fence, and two stanchions forming a fence defining an opening for placement of a gate. In particular, a first stanchion 302 is spaced apart from a second stanchion 304 which is spaced apart from a third stanchion 306. Each stanchion includes an upper rail 308 formed of a webbing material that extends from the trailer 30 having a first end 310 which is retractable into stanchion cap 312. Webbing 314 is retractable into stanchion cap 316 and webbing 318 is retractable into stanchion cap 320. The middle rail is formed by webbing 322 that is coupled to the trailer along element 320 and retractable into stanchion connector 324. Webbing 326 is retractable into stanchion connector 328, and webbing 330 is retractable into stanchion member 332. A lower rail has an end 334 with the webbing 336 retractable into stanchion element 338, lower webbing 340 retractable into stanchion element 342, and webbing element 344 retractable into stanchion element 346. The webbing retractions are similar to those commonly found in airport terminals. However, in this instance the webbing may include a electrical conduit wire wherein a low voltage shock can be used to keep a horse from attempting to exit the corral.

The second fence used in the corral includes webbing member 360 attached to trailer connector 362 and retractable into stanchion element 364. Webbing 366 is retractable into stanchion element 368. A middle rail is formed by webbing 370 attached is to trailer 30 along end 372 and retractable into stanchion element 374, middle webbing 376 is attachable to stanchion element 378. Finally, lower webbing 380 is attachable to element 382 and fits into retractable element 384, and webbing 386 is retractable into stanchion element 388.

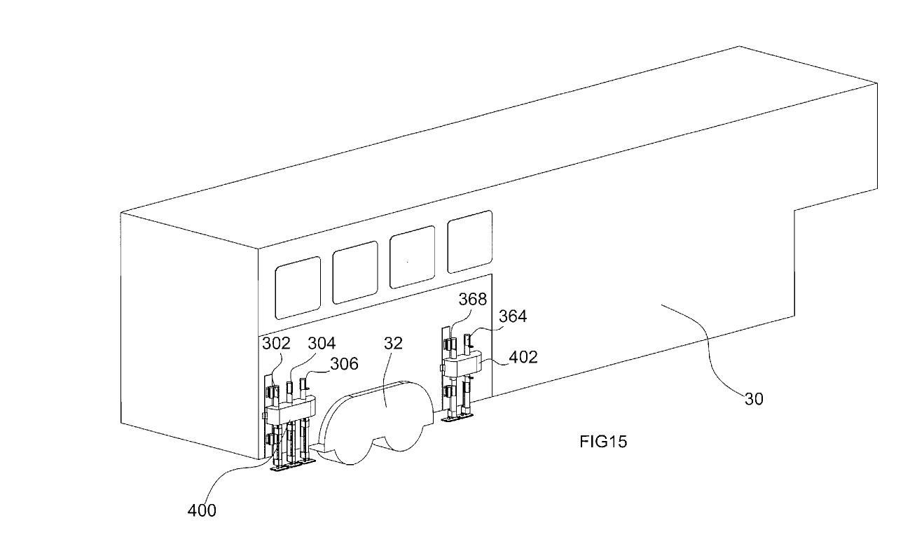

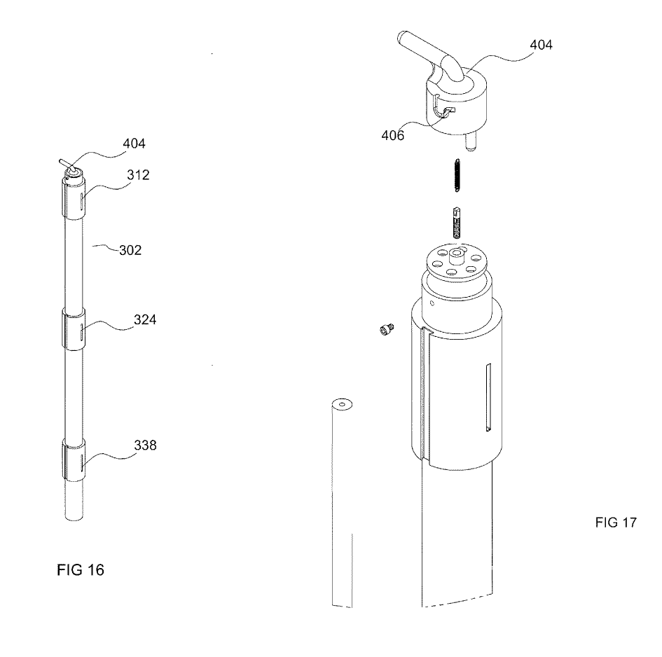

A gate 390 is placed between the stanchion elements 320 and 368 to provide opening to the corral for egress and ingress of a horse. As shown in FIG. 15, when the webbing is retracted into the individual stanchions, the stanchions are held against the trailer using bracket 400 to hold stanchions 302, 304, and 306. Bracket 402 will hold stanchions 368 and 364 in a position in front of the wheel cover 32. FIG. 16 depicts a stanchion 302 which is typical of the stanchions having retractable element 312 along the top, 324 in the middle, and 338 along the bottom. A locking mechanism 404 includes a rotating element 406 so as to maintain the webbing in a fixed position. As with the previous embodiment, each of the stanchions include adjustable legs so as to position the webbing rails a height dependent upon the ground elevation.

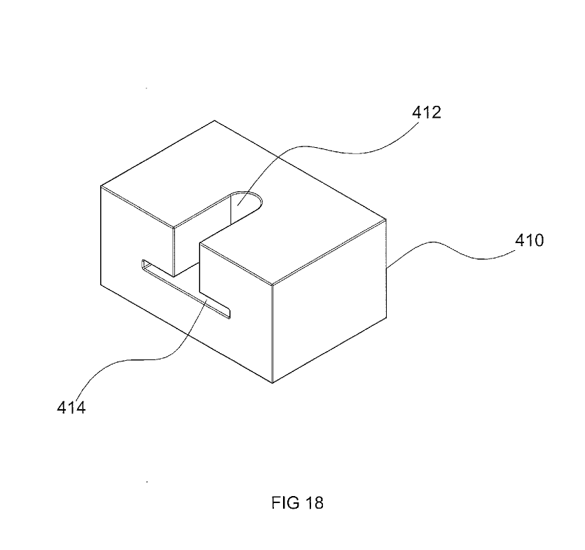

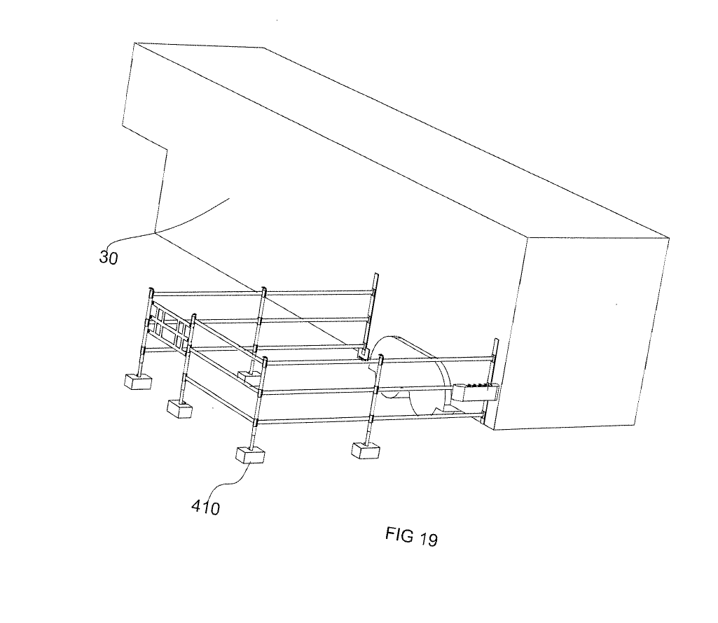

FIG. 18 depicts a weighted box support 410 having a a groove 412 and placement slot 414, which allows insertion of the stanchion feet, as depicted in FIG. 19. The stanchion feet fit in the grooves and placement slot wherein the supports can be filled with sand or water for use in a temporary manner. Alternatively the supports could be filled with cement providing a rigid type stanchion which allows the supports to remain portable but of sufficient weight to prohibit movement of the stanchions should they be impacted by a horse.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A horse trailer corral comprising:
a first fence section having a substantially rectangular shape with an inner end and an outer end, said inner end hingedly coupled to a trailer and said outer end movable from a storage position placed along a side of the trailer to a deployed position perpendicular to the trailer;
a second fence section having a substantially rectangular shape with a first end and a second end, said first end hingedly coupled to said outer end of said first fence section end, said second end of said second fence section movable from a stored position placed along a side of first section inner end to a deployed position parallel to the side of the trailer;
a third fence section having a substantially rectangular shape with a proximal end and a distal end, said proximal end hingedly coupled to the side of the trailer side and said distal end movable from a stored position placed along the side of the trailer to a deployed position adjacent said second end of said second fence section;
a gate placed between said second fence section and said third fence section wherein said fence sections form a corral and said gate allows access to the corral.

2. The horse trailer corral of claim 1 wherein each said fence panel section is constructed of a plurality of rails positioned horizontally between each end of each fence panel section.

3. The horse trailer corral of claim 2 wherein said rails are tubular aluminum.

4. The horse trailer corral of claim 2 wherein said rails are telescoping.

5. The horse trailer corral of claim 2 wherein at least one said rail is constructed of plastic.

6. The horse trailer corral of claim 2 wherein at least one said rail is constructed of a retractable textile material strip.

7. The horse trailer corral of claim 1 wherein each fence panel section includes an adjustable foot, said adjustable foot having a base with a threaded rod rotatably secured to a reciprocal threaded receiver positioned on each end of the fence panel section wherein rotation of said threaded rod is used to position the base on the ground to support said fence section.

8. The horse trailer corral of claim 7 wherein said adjustable foot is hinged to allow placement of the foot in a horizontal or vertical position.

9. The horse trailer corral of claim 1 wherein said fence panels are adjustable in height.

10. The horse trailer corral of claim 1 wherein said fence panels are adjustable in length.

11. The horse trailer corral of claim 1 including a bracket secured to the trailer, said bracket constructed and arranged to secure said fence sections in a storage position juxtapositioned with the side of the trailer.

12. The horse trailer corral of claim 11 including a bucket securable to said bracket, wherein said bucket can be used to hold water or feed.
